(19) United States
(12) Patent Application Publication
(10) Pub. No.: US 2016/0187075 A1
(43) Pub. Date: Jun. 30, 2016

(54) HEAT EXCHANGE UNITS

(71) Applicant: THERMO KING CORPORATION, Minneapolis, MN (US)

(72) Inventor: John Jacob Shaw, Burnsville, MN (US)

(21) Appl. No.: 14/583,854

(22) Filed: Dec. 29, 2014

(51) Int. Cl. F28F 9/007; B23P 15/26; F28F 13/12; F28F 21/06; F28F 1/00

(52) U.S. Cl. CPC F28F 9/007; F28F 21/06; F28F 1/00; F28F 13/12; B23P 15/26

(57) ABSTRACT

A heat exchange unit that includes a plurality of heat exchange components and a heat exchange support assembly is provided. The heat exchange support assembly includes a first non-metallic shell, a second non-metallic shell configured to cooperate with the first non-metallic shell to form the heat exchange support assembly, and a plurality of cavities defined by the first and second non-metallic shells for securing the heat exchange components respectively.

### FIELD

This disclosure relates generally to refrigeration systems and, more particularly, to heat exchange units and methods of assembling the heat exchange units.

### BACKGROUND

Refrigeration systems for refrigerated transport units and HVAC systems commonly utilize separate/remote condenser and/or evaporator units, with one or more of these units being mounted in a conditioned space. The heat exchange support assemblies typically include a sheet metal box which houses an evaporator coil, a fan and other associated components of the heat exchange unit. Typically, multiple material types are used to construct support frames and other support structure members (e.g., clamps, connectors, etc.) for supporting and retaining components of the heat exchange units and providing airflow management within a refrigerated transport unit. As a result, high material cost and labor cost are involved in assembling a heat exchange unit. Also, the use of multiple support structural members can undesirably increase the weight of the heat exchange unit.

### SUMMARY

This disclosure relates generally to refrigeration systems and, more particularly, to heat exchange units and methods of assembling the heat exchange units.

In some embodiments, a heat exchange support assembly is configured to retain heat exchange components within, e.g., a support frame, thereby allowing heat exchange components to be secured in the e.g., support frame without requiring a separate structural member for attachment. As a result, labor cost and material cost associated with assembling the heat exchange unit can be reduced.

In some embodiments, the heat exchange support assembly can be made of non-metallic materials such as, for example, a composite material. In some embodiments, the non-metallic material can be an expandable polypropylene foam, thereby reducing the overall weight of the heat exchange unit. In some embodiments, a heat exchange unit includes a heat exchange coil, at least one heat exchange fan, a refrigerant tube, and a heat exchange support assembly. The heat exchange support assembly can define a plurality of cavities that secure the heat exchange coil, the fan and the refrigerant tube, respectively.

In one embodiment, a heat exchange unit that includes a plurality of heat exchange components and a heat exchange support assembly is provided. The heat exchange support assembly includes a first non-metallic shell, a second non-metallic shell configured to cooperate with the first non-metallic shell to form the heat exchange support assembly, and a plurality of cavities defined by the first and second non-metallic shells for securing the heat exchange components respectively.

In another embodiment, a heat exchange support assembly for a heat exchange unit is provided. The heat exchange support assembly includes a first non-metallic shell and a second non-metallic shell configured to cooperate with the first non-metallic shell to form the heat exchange support assembly. The heat exchange support assembly also includes a plurality of cavities defined by the first and second non-metallic shells for securing heat exchange components of the heat exchange unit.

In yet another embodiment, a method of assembling a heat exchange unit that includes a plurality of heat exchange components within a heat exchange support assembly having a first non-metallic shell, a second non-metallic shell configured to cooperate with the first non-metallic shell to form the heat exchange support assembly, and a plurality of cavities defined by the first and second non-metallic shells for securing each of the heat exchange components respectively. The method includes securing each of the heat exchange components in a respective cavity of the plurality of cavities defined in the first non-metallic shell via an interference fit. The method also includes securing the second non-metallic shell over the first non-metallic shell so that the first and second non-metallic shells cooperate with each other to form the heat exchange support assembly with the heat exchange components secured therein.

The details of one or more embodiments are set forth in the accompanying drawings and the description below. Other features, objects and advantages of the embodiments will be apparent from the description and drawings, and from the claims.

### DESCRIPTION OF THE DRAWINGS

FIG. 1 illustrates different embodiments of transport refrigeration systems for a truck.

FIG. 2 is a schematic view of a refrigeration circuit of a TRS.

FIG. 3 is a perspective view of a heat exchange unit.

FIG. 4 illustrates a bottom shell portion of a heat exchange support assembly.

FIG. 5 illustrates a top shell portion of the heat exchange support assembly, which cooperates with the bottom shell portion of FIG. 4 to close the bottom shell portion.

FIG. 6 illustrates heat exchange components to be secured in the heat exchange support assembly of FIG. 4.

FIG. 7 illustrates a shell portion of FIG. 4, with the heat exchange components of FIG. 6 being secured within the bottom shell portion.

FIG. 8 illustrates a section of a shell portion of a heat exchange support frame which includes a non-metallic layer.

FIG. 9 illustrates a section of a shell portion of a heat exchange support frame which includes a non-metallic layer and an exterior layer.

### DETAILED DESCRIPTION

As used herein, the term “refrigerated transport unit” generally refers to, for example, a conditioned trailer, container, railcar, bus or other type of transport unit, etc. The term “heat exchange components” refer to parts of a heat exchange unit, including but not limited to heat exchange coils, fans, refrigerant tubes, defrost heater and an associated temperature sensor, drain pan assemblies, one or more additional valves, one or more sensors, one or more electrical harnesses, one or more electric lines, and the like. The term “temperature rating” refers to the temperature which a material is able to withstand for a given period without significant deterioration. The terms “above,” “on,” “under,” “top,” “bottom,” “up,” “down,” “upper,” “lower,” “horizontal,” “vertical,” “front,” “rear,” “left,” “right” and the like used herein are in reference to the relative positions of the heat exchange components of a heat exchange unit, as oriented in the specific figures being described. These terms are not meant to be limiting in any way.

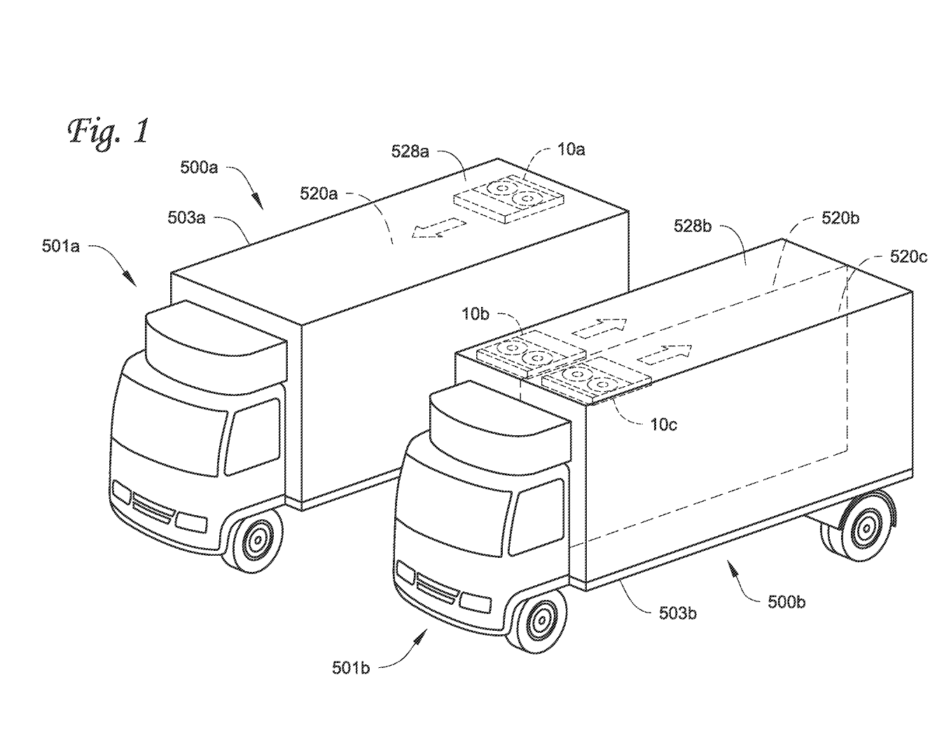

Referring to FIG. 1, a first truck 501a including a transport refrigeration system (TRS) 500a is provided. The TRS 500a includes a heat exchange unit 10a mounted on an upper wall 528a of a refrigerated transport unit 503a within a cooling space 520a. In this embodiment, the heat exchange unit 10a is an evaporator unit. However, in other embodiments the heat exchange unit can also be, e.g., a condenser unit.

FIG. 1 also illustrates a second truck 501b including a transport refrigeration system (TRS) 500b. The TRS 500b includes heat exchange units 10b and 10c such as evaporator units mounted on an upper wall 528b of a refrigerated transport unit 503b within cooling spaces 520b and 520c, respectively. In this embodiment, the heat exchange unit 10b and 10c are evaporator units. However, in other embodiments the heat exchange units can also be, e.g., a condenser unit.

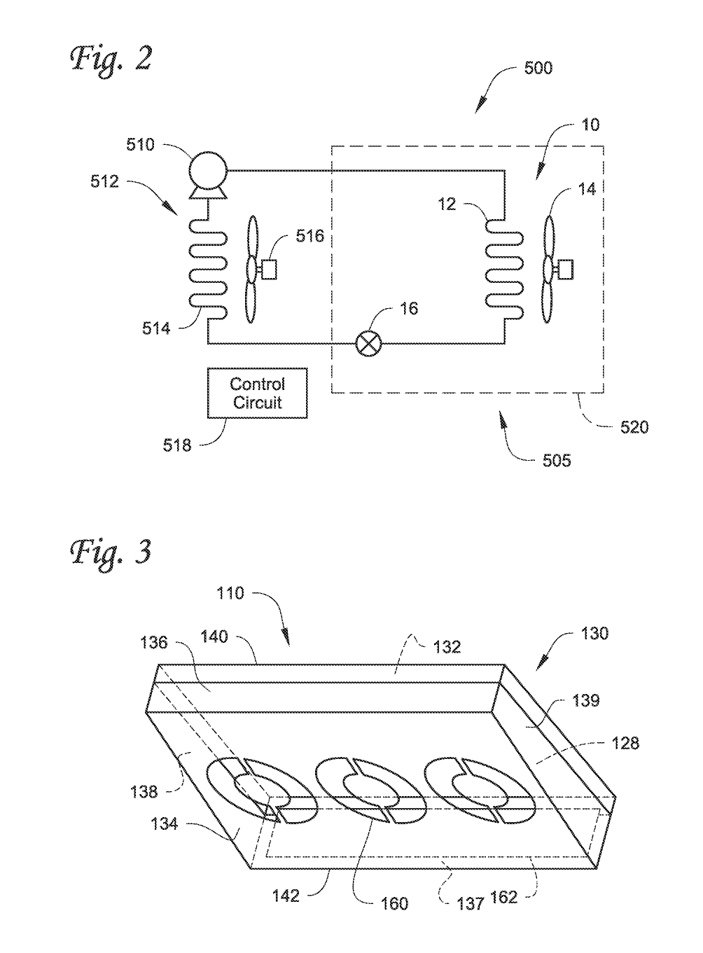

FIG. 2 is a schematic view of a refrigeration circuit of a refrigeration system. As shown in FIG. 2, a TRS 500 may include a refrigeration circuit 505. The refrigeration circuit 505 may include a compressor 510 driven by an engine (not shown), which is configured to circulate refrigerant in the TRS 500. The TRS 500 also includes the heat exchange unit 10 as shown in FIG. 1 which has a heat exchange coil 12, at least one heat exchange fan 14, and an expansion valve 16. The heat exchange unit 10 is configured to allow air in a cooling space 520 to pass across the heat exchange coil 12 to provide cooling in the cooling space, respectively.

The TRS 500 also includes a condenser unit 512 having a condenser coil 514 and at least one condenser fan 516, and a controller 518 configured to control operation of the TRS 500. The condenser unit 512 is configured to allow refrigerant that carries heat to flow through the condenser coil 514, thereby transferring the heat to the environment.

The cooling space 520 is depicted by a dash line box in FIG. 2. It is to be understood that the cooling space 520 can be various types of indoor spaces, such as a cargo space of a refrigerated transport unit, or a conditioned space for residence, commercial or industrial refrigeration systems. It is also to be understood that the TRS 500 may include additional components that are commonly employed within refrigeration systems that are not illustrated or discussed, such as, refrigerant tubes, defrost heater and an associated temperature sensor, etc.

FIG. 3 is a perspective view of a heat exchange unit. As shown in FIG. 3, a heat exchange unit 110 includes a heat exchange support assembly 130 for supporting and retaining components of the heat exchange unit 110 including a heat exchange coil, a heat exchange fan, an expansion valve, one or more refrigerant tubes inside the heat exchange support assembly 130. It is to be understood that the heat exchange unit 110 may also include additional components that are commonly employed within a heat exchange unit that are not illustrated or discussed, such as, one or more drain passages, one or more drain pan assemblies, one or more additional valves, one or more sensors, one or more electrical harnesses, and one or more electric lines.

The heat exchange support assembly 130 has a generally rectangular shape, including a top surface 132, a bottom surface 134, a front side 136, a rear side 137, a left side 138 and a right side 139. In some embodiments, the heat exchange support assembly 130 has an top shell portion 140 and a bottom shell portion 142 coupled to each other to secure the heat exchange components of the heat exchange unit 110 in the heat exchange support assembly 130. In the depicted embodiment as shown in FIG. 3, an air flow inlet 160 is defined in a middle section of the bottom shell portion 142, thereby allowing air to be drawn into an interior space 128 defined by the top and bottom shell portions 140, 142. An elongate air flow outlet 162 is defined horizontally in the rear side 137 of the heat exchange support assembly 130 to allow air to be forced out into the cooling space.

The top shell portion 140 includes an inner surface (not shown) to which the heat exchange components of the heat exchange unit 110 may be attached. Likewise, the bottom shell portion 142 includes an inner surface (not shown) to which the heat exchange components of the heat exchange unit 110 may be attached.

In some embodiments, the top surface 134 of the heat exchange support assembly 130 has one or more mounting mechanisms for mounting the heat exchange unit 110 to, for example, a bottom surface of an upper wall 528 (shown in FIG. 1) of the cooling space 520 by a suitable attachment mechanism, such as an adhesive, a clip, a snap fit connection, or the like. In some embodiments, the heat exchange unit 110 can be attached to studs protruding from the ceiling. For example, a shell of the heat exchange unit 110 can include through holes for the studs with a nut and washer holding the heat exchange unit 110 in place. The washer can be large/square to help with surface area/structure. In other embodiments, the heat exchange unit 110 can include a series of mounting layers to allow a main body/weight of the heat exchange unit components to remain suspended while a cover layer and a first layer are taken off. In some embodiments, when the heat exchange unit 110 is attached to the upper wall 528 of the cooling space 520, the bottom shell portion 144 extends generally from a higher elevation at the front side 136 to a lower elevation at the rear side 137.

In some embodiments, the heat exchange support assembly 130 can include non-metallic shells coupled to each other for enclosing components of the heat exchange unit 110. The non-metallic shells can be made from non-metallic materials, such as, for example, expandable polypropylene foam. In some embodiments, the non-metallic shells can be a composite of fiberglass or other reinforced materials, such as a plastic material that incorporates a thin plastic or a metal tub. The non-metallic shells can be used to provide structural support for the heat exchange unit 110, and to provide mounting features for the heat exchange unit 110. The non-metallic material is configured to be lightweight to potentially increase fuel economy of the TRS by reducing engine load while have sufficient strength to support and secure the heat exchange components of the heat exchange unit 110.

It is to be understood that the top shell portion 140 may be made from a first non-metallic material, and the bottom shell portion 142 may be made from a second non-metallic material. In some embodiments, the first and second non-metallic materials are the same type of material.

It is to be understood that the heat exchange support assembly 130 is not limited to the configuration including the top shell portion 140 and a bottom shell portion 142, but can be constructed in other configurations, as long as the heat exchange components of the heat exchange unit 110 can be supported and retained in the heat exchange support assembly 130 and readily accessed for maintenance of the heat exchange unit 110.

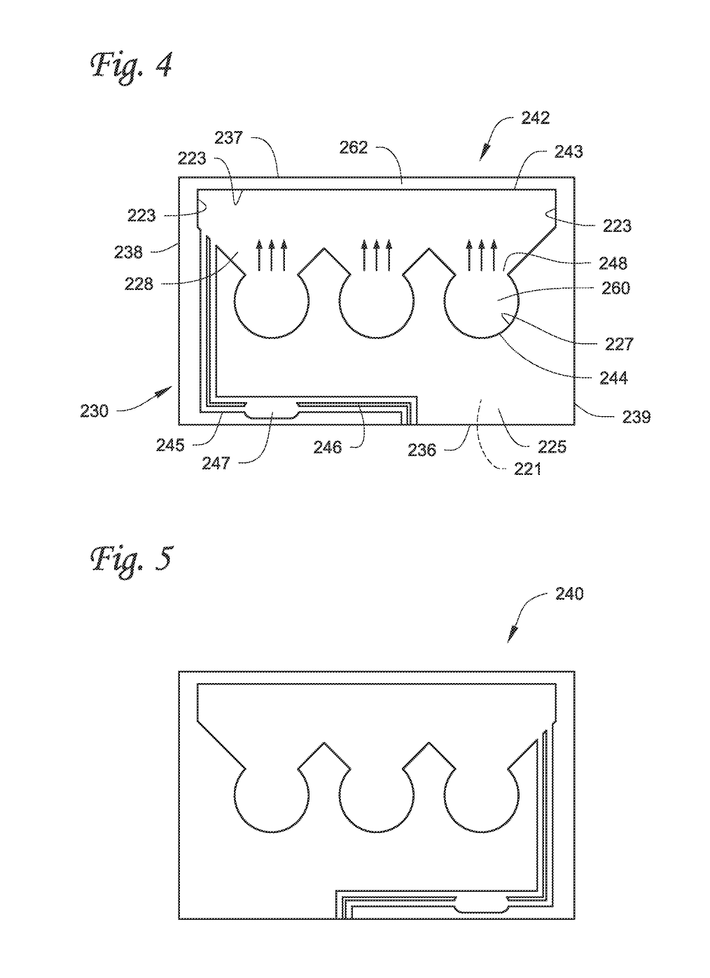

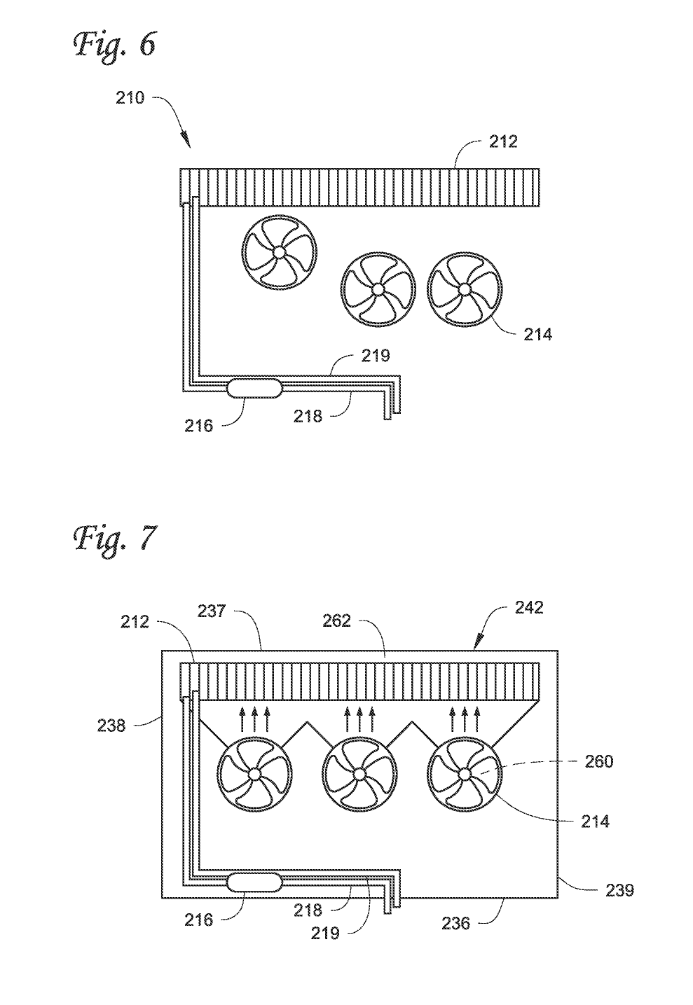

FIGS. 4-6 illustrate a heat exchange unit 210 having a non-metallic heat exchange support assembly. FIGS. 4 and 5 show an open bottom shell portion 242 of a heat exchange support assembly 230 made of a non-metallic material and a top shell portion 240 that cooperates with the bottom shell portion 242 to close off the bottom shell portion 242. FIG. 6 illustrates the heat exchange unit 210 that has a heat exchange coil 212, three heat exchange fans 214, a supply refrigerant tube 218, a discharge refrigerant tube 219 and an expansion valve 216.

As shown in FIGS. 4-5, the open bottom shell portion 242 has an inner surface 225 to which the heat exchange components of the heat exchange unit 210 may be attached. A coil compartment 243 is defined in the bottom shell portion 242 adjacent a rear side 237 of the bottom shell portion 242 for supporting and retaining the heat exchange coil 212. The coil compartment 243 is an elongate cavity configured to correspond to the contour of the heat exchange coil 212. As shown in FIG. 6, the coil compartment 243 extends between a left side 238 and a right side 239 of the heat exchange support assembly 230. The coil compartment 243 has a bottom wall 221 forming a bottom of the compartment 243 and three side walls 223 forming a rear side, a left side and a right side of the compartment 243. In some embodiments, the bottom wall 221 can include a drain pan at the bottom of the heat exchange unit 210 to collect condensation.

Referring to FIGS. 4-6, three spaced apart fan compartments 244 are formed in a middle section between a front side 236 and the rear side 237 of the heat exchange support assembly for receiving the three heat exchange fans 214, respectively. In some embodiments, the fan compartments 244 are in the form of through openings configured to correspond with the shape of the heat exchange fans 214. The bottom shell portion 242 when cooperating with the top shell portion 240 defines air flow inlets 260 in communication with the fan compartments 244. The bottom shell portion 242 when cooperating with the top shell portion 240 also defines an air flow outlet 262 that is positioned to be in communication with the coil compartment 243. In operation, the fan compartment 244 cooperates with three air flow inlets 260 to allow air to come into the support frame 230, pass through the interior space 228, pass through the heat exchange coil 218 and exit to the outside environment.

In some embodiments, the fan compartments 244 are positioned in front of the coil compartment 243. Each fan compartment 244 has a generally circular shape having a side wall 227, leaving a rear portion of the side wall 227 open toward the coil compartment 243. This allows the fan compartment 244 to be in communication with the coil compartment 243. This configuration allows air to be drawn from the three air flow inlets 260 by the heat exchange fans 214, forced through the heat exchange coil 212 in a direction as shown by arrows and exit the heat exchange unit 210 from an air flow outlet 262. For example, the top and bottom shell portions 240, 242 can couple with each other to form molded chambers configured to contain the components of the heat exchange unit 210. The coupled top and bottom shell portions 240, 242 can also form integral air flow passages and ducts to direct the air between blowers and coils.

Also defined in the inner surface 225 of the bottom shell portion 242 are a supply tube channel 245 and a discharge tube channel 246 for supporting refrigerant supply and discharge tubes 218, 219, respectively. A section 247 of the supply tube channel 245 is enlarged to accommodate the expansion valve 216. The channels 245, 246 and the enlarged section 247 may have various cross section shapes, such as a cylindrical cross-sectional shape when the top shell portion 240 is coupled to the bottom shell portion 242.

In some embodiments, the compartments 243, 244, the channels 245, 246 and the enlarged section 247 are sized and shaped to firmly retain the heat exchange coil 212, the heat exchange fans 214, the refrigerant supply and discharge tubes 218, 219 and the expansion valve 216. In some embodiments, these heat exchange components are retained in the heat exchange support assembly using an interference fit between these heat exchange components and the heat exchange support assembly without assistance of other attachment members such as, for example, fasteners. In some embodiments, a heat exchange component can be retained in the heat exchange support assembly by an interference fit. In other embodiments, the heat exchange component can be retained to the heat exchange support assembly by interference fit together with attachment members such as, for example, fasteners, a combination of fasteners/special brackets, or the like.

Still referring to FIG. 4, the bottom shell portion 242 defines a plurality of integral air passages 248 that allow air to be drawn into the heat exchange support assembly 230 by the heat exchange fans 214 at the air flow inlets 260, flow through the heat exchange coil 212 and exit the heat exchange support assembly at the air flow outlet 262. Accordingly, the integral air passages 248 allow heat to be vented to the outside environment. In such circumstances, by providing a non-metallic heat exchange support assembly, separate air passage components are not needed. In some embodiments, the non-metallic materials are temperature resistant or within the temperature rating. In other embodiments, the top and bottom shell portions 240, 242 are made from special materials to shield the composite material from any high temperature refrigeration tubes. The moldability of the heat exchange support assembly allows the integral air passages 248 to be configured to route around the compartments 243, 244 and the channels 245, 246. Additionally, the integral air passages 248 are configured with a shape that promotes air flow. The dimension of the integral air passages 248 can be maximized and the transitions in the air passages 248 can be smoothened to help form efficient airflow, thereby reducing fan power requirement. The integral air passage 248 can be configured to include a linear path or a nonlinear path between the air flow inlets 260 and the air flow outlet 262.

Referring to FIG. 7, when assembling the heat exchange unit 210, the open bottom shell portion 242 of the heat exchange support assembly in FIG. 6 is closed off by the top shell portion 240 when the top shell portion 240 is coupled to the bottom shell portion 242. The top and bottom shell portions 240, 242 cooperate with each other, thereby providing support to and retaining the heat exchange components of the heat exchange unit 210 within the interior space 228, including loose components, such as electrical harnesses, electric lines, sensors, additional valves, or the like. In some embodiments, the components of the heat exchange unit 210 are maintained in the heat exchange support assembly without attachment members, such as fasteners. The top shell portion 240 and the bottom shell portion 242 can be locked together via, for example, a snap fit construction, a tight fit/friction construction, an interference fit construction, a slide fit construction, one or more fasteners, or combinations thereof.

The heat exchange unit 210 is then attached to a bottom surface of an upper wall 528 (shown in FIG. 1) of the cooling space 520 by suitable attachment mechanisms, such as adhesive, snap fit, fasteners, through holes.

It is to be understood that the shape and position of the compartments 243, 244, the channels 246, 246, the enlarged section 247 and the integral air passages 248 are meant to be exemplary only. It is to be understood that more cavities, such as compartments, channels, or the like, may be formed in the heat exchange support assembly 230 for supporting and retaining other components of the heat exchange unit 210 such as one or more electrical harnesses, electric lines, sensors and additional valves, etc. In some embodiments, the heat exchange support assembly 230 may include a compartment for storing electrical drawings/installation/maintenance materials. The number, size and location of such compartments, channels and passages can be based on the particular heat exchange model being used, taking into account of the physical properties of the non-metallic material.

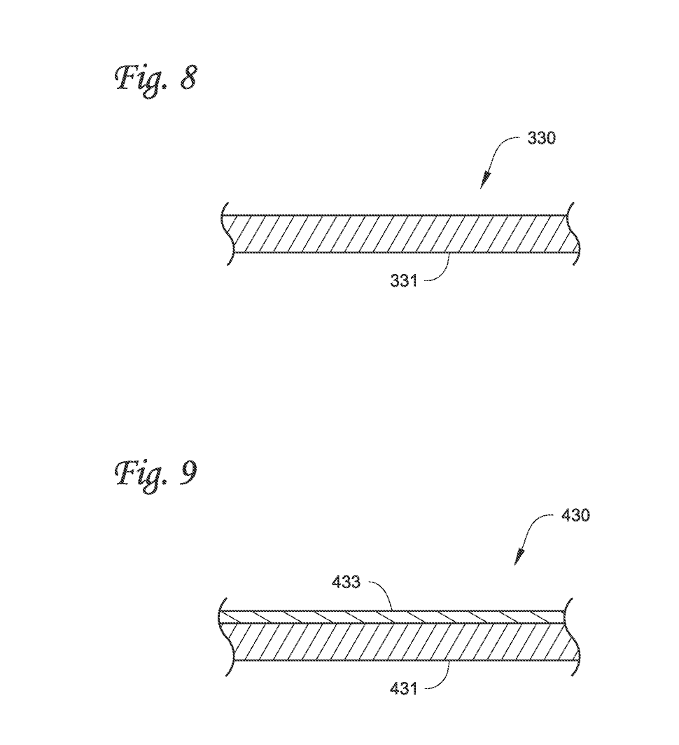

As shown in FIG. 8, in some embodiments, a heat exchange support assembly 330 has a non-metallic layer 331 including a molded surface finish. In other embodiments, as shown in FIG. 9, a heat exchange support assembly 430 includes a non-metallic layer 431 and an exterior layer 433 covering an outer surface of the non-metallic layer 331 to create a surface finish. The exterior layer 433 can be made of suitable material, such as plastic. The exterior layer 433 tracks the shape of the outer surface of the non-metallic layer 431 and has multiple openings aligned respectively with the air flow inlets, the air flow outlet, drain discharge opening and other openings defined at the outer surface of the non-metallic layer 431.

### Aspects:

It is noted that any of aspects 1-11 can be combined.

Aspect 1. A heat exchange unit, comprising:

a plurality of heat exchange components; and

a heat exchange support assembly, including:
a first non-metallic shell;
a second non-metallic shell configured to cooperate with the first non-metallic shell to form the heat exchange support assembly;
a plurality of cavities defined by the first and second non-metallic shells for securing the heat exchange components, respectively.
   Aspect 2. The heat exchange unit of aspect 1, wherein the heat exchange support assembly further includes an air flow inlet, an air flow outlet, and an integrally formed air passage defined by the first and second non-metallic shells that is configured to allow air to flow from an air flow inlet of the heat exchange unit to an air flow outlet of the heat exchange unit.
   Aspect 3. The heat exchange unit of either of aspects 1 and 2, wherein the first and second non-metallic shells are configured to allow the heat exchange components to be secured in the respective cavities via an interference fit.
   Aspect 4. The heat exchange unit of any of aspects 1-3, wherein the first non-metallic shell and the second non-metallic shell are made of polypropylene foam.
   Aspect 5. The heat exchange unit of any of aspects 1-4, wherein the heat exchange components include a heat exchange coil, a heat exchange fan, and a refrigerant tube.
   Aspect 6. A heat exchange support assembly for a heat exchange unit, comprising:

a first non-metallic shell;

a second non-metallic shell configured to cooperate with the first non-metallic shell to form the heat exchange support assembly;

a plurality of cavities defined by the first and second non-metallic shells for securing heat exchange components of the heat exchange unit.

Aspect 7. The heat exchange support assembly of aspect 6, further comprising an air inlet, an air outlet and an integrally formed air passage defined by the first and second non-metallic shells that allows air to flow from an air flow inlet of the heat exchange unit to an air flow outlet of the heat exchange unit.
Aspect 8. The heat exchange support assembly of either of aspects 6 and 7, wherein the first and second non-metallic shells are configured to allow heat exchange components to be secured in the respective cavities via an interference fit.
Aspect 9. The heat exchange support assembly of any of aspects 6-8, wherein the first non-metallic shell and the second non-metallic shell are made of polypropylene foam.
Aspect 10. A method of assembling a heat exchange unit that includes a plurality of heat exchange components within a heat exchange support assembly having a first non-metallic shell, a second non-metallic shell configured to cooperate with the first non-metallic metallic shell to form the heat exchange support assembly, and a plurality of cavities defined by the first and second non-metallic shells for securing each of the heat exchange components respectively, the method comprising:

securing each of the heat exchange components in a respective cavity of the plurality of cavities defined in the first non-metallic shell via an interference fit; and

securing the second non-metallic shell over the first non-metallic shell so that the first and second non-metallic shells cooperate with each other to form the heat exchange support assembly with the heat exchange components secured therein.

Aspect 11. The method of aspect 10, wherein securing each of the heat exchange components in the respective cavity of the plurality of cavities defined in the first non-metallic shell via an interference fit includes one or more of:

securing a heat exchange coil in a heat exchange coil shaped cavity of the plurality of cavities in the first non-metallic shell,

securing a heat exchange fan in a heat exchange fan shaped cavity of the plurality of cavities in the first non-metallic shell, and

securing a refrigerant tube in a refrigerant tube shaped cavity of the plurality of cavities in the first non-metallic shell.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A heat exchange unit, comprising:
a plurality of heat exchange components; and
a heat exchange support assembly, including:
a first non-metallic shell;
a second non-metallic shell configured to cooperate with the first non-metallic shell to form the heat exchange support assembly;
a plurality of cavities defined by the first and second non-metallic shells for securing the heat exchange components, respectively.

2. The heat exchange unit of claim 1, wherein the heat exchange support assembly further includes an air flow inlet, an air flow outlet, and an integrally formed air passage defined by the first and second non-metallic shells that is configured to allow air to flow from an air flow inlet of the heat exchange unit to an air flow outlet of the heat exchange unit.

3. The heat exchange unit of claim 1, wherein the first and second non-metallic shells are configured to allow the heat exchange components to be secured in the respective cavities via an interference fit.

4. The heat exchange unit of claim 1, wherein the first non-metallic shell and the second non-metallic shell are made of polypropylene foam.

5. The heat exchange unit of any of claim 1, wherein the heat exchange components include a heat exchange coil, a heat exchange fan, and a refrigerant tube.

6. A heat exchange support assembly for a heat exchange unit, comprising:
a first non-metallic shell;
a second non-metallic shell configured to cooperate with the first non-metallic shell to form the heat exchange support assembly;
a plurality of cavities defined by the first and second non-metallic shells for securing heat exchange components of the heat exchange unit.

7. The heat exchange support assembly of claim 6, further comprising an air inlet, an air outlet and an integrally formed air passage defined by the first and second non-metallic shells that allows air to flow from an air flow inlet of the heat exchange unit to an air flow outlet of the heat exchange unit.

8. The heat exchange support assembly of claim 6, wherein the first and second non-metallic shells are configured to allow heat exchange components to be secured in the respective cavities via an interference fit.

9. The heat exchange support assembly of claim 6, wherein the first non-metallic shell and the second non-metallic shell are made of polypropylene foam.

10. A method of assembling a heat exchange unit that includes a plurality of heat exchange components within a heat exchange support assembly having a first non-metallic shell, a second non-metallic shell configured to cooperate with the first non-metallic shell to form the heat exchange support assembly, and a plurality of cavities defined by the first and second non-metallic shells for securing each of the heat exchange components respectively, the method comprising:
securing each of the heat exchange components in a respective cavity of the plurality of cavities defined in the first non-metallic shell via an interference fit; and
securing the second non-metallic shell over the first non-metallic shell so that the first and second non-metallic shells cooperate with each other to form the heat exchange support assembly with the heat exchange components secured therein.

11. The method of claim 10, wherein securing each of the heat exchange components in the respective cavity of the plurality of cavities defined in the first non-metallic shell via an interference fit includes one or more of:
securing a heat exchange coil in a heat exchange coil shaped cavity of the plurality of cavities in the first non-metallic shell,
securing a heat exchange fan in a heat exchange fan shaped cavity of the plurality of cavities in the first non-metallic shell, and
securing a refrigerant tube in a refrigerant tube shaped cavity of the plurality of cavities in the first non-metallic shell.
